(19) United States
(12) Patent Application Publication
(10) Pub. No.: US 2019/0120098 A1
(43) Pub. Date: Apr. 25, 2019

(54) VALVE, OIL SEPARATOR, AND VENTILATION SYSTEM

(71) Applicant: REINZ-Dichtungs-GmbH, Neu-Ulm (DE)

(72) Inventors: Markus Schiele, Neu-Ulm (DE); Yagiz Yaman, Neu-Ulm (DE)

(21) Appl. No.: 16/146,014

(22) Filed: Sep. 28, 2018

(30) Foreign Application Priority Data
Sep. 29, 2017 (DE) 20 2017 105 964.2

(51) Int. Cl. F01M 13/00; F02M 35/10; F01M 13/02; F01M 13/04; F16K 17/02

(52) U.S. Cl. CPC F01M 13/0011; F02M 35/10222; F01M 13/022; F01M 13/04; F01M 2013/0461; F16K 17/02; F01M 2013/026; F01M 2013/0044; F01M 2013/0055; F02M 35/10229

(57) ABSTRACT

A valve, an oil separator, and a ventilation system are described. These are used particularly in internal combustion engines, for example for separating oil mist or oil droplets from blow-by gases (crankcase gases). In particular a valve which can be used for example as a bypass valve in a ventilation system is described.

### BACKGROUND

A valve, an oil separator, and a ventilation system are described. These are used particularly in internal combustion engines, for example for separating oil mist or oil droplets from blow-by gases (crankcase gases). A valve which can be used for example as a bypass valve in a ventilation system is also described.

Particularly in internal combustion engines, it is necessary to reliably discharge the blow-by gases from the crankcase or the oil sump. This usually takes place by feeding the blow-by gases back into the intake tract of the internal combustion engine and then burning said gases together with the fuel mixture. This ensures that the blow-by gases are not emitted into the environment.

The blow-by gases contain oil mist or oil droplets, which are separated out of the blow-by gases before the blow-by gases are fed back into the intake tract. To this end, an oil separator is usually arranged in the ventilation system. It is necessary and prescribed by law that ventilation of the crankcase is ensured in each operating state of the internal combustion engine. Even if the oil separator becomes clogged or sooted and/or in particular operating states of the internal combustion engine, it must be ensured that the blow-by gases are conducted from the crankcase into the intake tract. Bypass valves are therefore usually provided for this situation, which make it possible to bypass the oil separator if the oil separator is clogged or sooted or is not fully functional in some other way and cannot itself ensure reliable ventilation of the crankcase. If simple valves are used in the bypass for this purpose, the blow-by gas is conducted into the intake tract in largely uncleaned form.

Therefore, a further oil separator is optionally arranged in the bypass in addition to the valve. The design of the bypass is therefore expensive.

This is where the present device comes into play, the object thereof being to provide a valve which is inexpensive and which at the same time provides an oil separating function. In addition, the present device aims to provide an oil separator and a ventilation system in which both the valve function and an oil separating function are realized in the bypass in an inexpensive manner.

### SUMMARY

The valve may have a valve seat having a valve opening and a valve bearing member which surrounds the valve opening and which is designed for the bearing of a valve closure member, for example a valve plate. In the closed position of the valve, the valve closure member bears against the valve bearing member and closes the valve. To open the valve, the valve closure member lifts away from the valve bearing member and exposes the valve opening. The valve closure member is part of a valve disc. It is held on a retaining element via at least one retaining arm, the retaining element and the valve closure member being connected to one another via the retaining arm in a flexible manner. This enables the valve closure member to move away from or towards the valve bearing member in order to open and close the valve.

The valve disc, including the retaining element, the at least one retaining arm and the valve closure member is designed such that at least one through-opening is formed between at least two of the parts thereof, namely the retaining element, the at least one retaining arm and the valve closure member. This applies both in the closed position and in the open position of the valve. The valve has a separating element which extends through the through-opening at least in the open position of the valve. This separating element is therefore located outside of the valve opening and at least partially surrounds the valve bearing member.

In the open position of the valve, therefore, a slot-shaped opening is formed between the valve bearing member and the valve closure member, so that gases can flow through the valve opening and this slot-shaped opening from one side of the valve to the other side of the valve. Upon leaving the slot-shaped opening between the valve bearing member and the valve closure member, at least a portion of the through-flowing gases impinge upon the separating element that is located radially outside. Oil mist or oil droplets are then separated out of the impinging gases at the separating element. By virtue of the separating element, therefore, an oil separating function is realized in the valve in addition to the valve function.

One or more separating elements may be provided, wherein advantageously the one or more separating elements completely surround the valve seat along the entire circumference of the latter. In this case, most of the gases are directed from the valve closure member towards the separating elements, so that an oil separating function is ensured for all the gases flowing through the valve.

The separating elements may extend through the through-openings between the valve closure member and the retaining element also in the closed state of the valve; however, it is sufficient if they do so at least in the open position of the valve. Advantageously, the separating element(s) and the edges of the through-openings do not make contact with one another, so that the valve closure member can move along the separating elements in a friction-free manner.

If multiple retaining arms are provided between the valve closure member and the retaining element, multiple through-openings may also be formed. An individual separating element or else in each case multiple separating elements may then be arranged in each of the through-openings.

If the retaining arms are arranged in a spiral shape around the valve closure member, spiral-shaped through-openings are created. Advantageously, the retaining arms may intersect one another as viewed in the radial direction in the plane of the valve closure member, so that the through-openings also overlap one another when viewed in the same way (that is to say in the radial direction). In this case, the separating elements provided in the through-openings may also overlap one another, as viewed in this radial direction, so that the valve closure member is completely surrounded by separating elements as viewed in the radial direction. The flow path of at least most of the gases flowing through the valve then leads firstly to the separating elements and then laterally through between the separating elements and/or along the separating elements in the axial direction. Said flow path is therefore configured in a labyrinth-like manner, so that the separating elements form baffle separators in the form of a labyrinth separator.

The separating elements themselves may individually, in multiples or as a whole be formed as baffle elements, in particular as baffle plates. If multiple separating elements are present, these may be configured differently, for example with a different height, wall thickness, length (that is to say along a through-opening) and in terms of the length of the overlap thereof with adjacent separating elements. It is also possible to form the separating elements from open-pore or lattice-like material or with an open- or closed-pore or lattice-like surface. All types of conventional baffle separating elements are possible here.

The separating elements may be formed in one piece with the valve seat or may be connected to the valve seat with a form fit and/or with a friction fit and/or by an adhesive join. It is possible for example to produce the separating elements separately and to connect these to the valve seat by way of a plug-in connection. At the same time, however, it is also possible to manufacture the valve seat and the separating elements together in one piece. Given a suitable design of the separating elements, no undercuts are formed in the one-piece design of the valve seat and the separating elements, so that injection moulding methods may be used for example.

However, the separating elements may also be mounted in a separate element, for example downstream of the gases flowing through the valve.

For stabilization purposes, the separating elements may also be connected to one another, for example by webs or the like.

If the retaining arms surround the valve closure member in a spiral shape, a rotation of the valve closure member about its central axis, which is perpendicular to the plane of the valve closure member, or the central axis of the valve opening takes place when the valve is opened and the valve closure member lifts away from the valve seat. This can be taken into account by angling the lateral edges of the separating elements such that the lateral edges of the separating elements maintain a distance from the ends of the through-openings that is identical or similar during the movement in the case of such a rotating opening movement of the valve closure member. This ensures that the valve disc and the separating elements do not come into contact with one another, even when the valve closure member rotates about its central axis during opening and closing. Of course, however, the separating elements may also be designed to be sufficiently narrow from the outset, so that they do not come into contact with the valve disc in any operating state of the valve. Avoiding contact between the separating elements and the valve disc is necessary in order to enable a friction-free movement of the valve closure member when opening and closing the valve.

The valve therefore performs not only a valve function but also additionally a separating function, as is necessary for example in order to separate oil mist or oil droplets from blow-by gases. This valve is inexpensive to produce and can easily be scaled or adapted particularly to the requirements in the respective use case, in particular with regard to the volumetric flow rate of the gases to be switched, the pressure conditions prevailing on both sides of the valve, the available space, the separating efficiency for oil mist and oil droplets, etc. It is also possible to arrange a plurality of such valves one behind the other or parallel to one another in the gas flow that is to be switched.

The valve is particularly suitable as a bypass valve for an oil separator, so that an oil separation, albeit a reduced oil separation, takes place also in the bypass flow, and is thus also suitable for use in a ventilation system for an internal combustion engine. In principle, however, the valve is also suitable for use as the sole oil separating element, particularly if only a small amount of space is available.

Steps of a method for producing an above-described valve, an above-described ventilation system, an above-described internal combustion engine and/or an above-described oil separator will be described below. This method is subject matter of the present application.

According to a first aspect, such a method for producing such a valve, ventilation system, internal combustion engine and/or oil separator may comprise for example at least the following steps:
producing, in one piece, a valve bearing member and one, several or all separating elements, and
then attaching a valve disc to the valve bearing member or a valve seat.

This is therefore a method for producing a valve of an oil separator or ventilation system which is characterized in that the valve bearing member and one, several or all separating elements are produced in one piece and then the valve disc is attached to the valve seat.

According to a second aspect, the method for producing such a valve, ventilation system, internal combustion engine and/or oil separator comprises for example at least the following steps:
separately producing the valve bearing member, valve disc and one, several or all separating elements, and
then attaching the valve disc and the at least one, but preferably several and in particular all separating elements to the valve seat.

This is therefore a method for producing a valve, an oil separator or a ventilation system which is characterized in that the valve bearing member, the valve disc and one, several or all separating elements are produced separately and then the valve disc and the produced separating elements are attached to the valve seat.

According to a third aspect, in the method for producing such a valve, ventilation system, internal combustion engine and/or oil separator, the separating elements are attached to the valve seat by means of a form-fitting and/or friction-fitting connection, in particular by means of a plug-in connection.

The method in this case is characterized in that the separating elements and the valve bearing member are connected to one another by means of a form-fitting and/or friction-fitting connection, in particular by means of a plug-in connection.

Valves, oil separators and ventilation systems, as well as methods for the production thereof, will be described below by way of example. In all the examples, identical and similar elements are provided with identical and similar reference signs, and therefore the description thereof will not be repeated.

The present device can be further developed in various ways. The following examples are combinations of different advantageous further developments. However, the present device according to claim 1 may also be further developed by individual aspects of the further embodiments and further developments shown here. Any combinations of such embodiments and further developments are also possible. This applies both to individual examples below, and to combinations of different examples below.

### DESCRIPTION OF THE DRAWINGS

In the drawings:

FIG. 1 shows one embodiment of an internal combustion engine having a ventilation system;

FIG. 2A shows a valve from above in different views;

FIG. 2B shows a valve of FIG. 2A in a perspective view;

FIG. 2C shows a sectional view of the valve of FIGS. 2A and 2B;

FIG. 2D shows a side view of the valve of FIGS. 2A to 2C;

FIG. 2E shows a vertical plan view of the valve of FIGS. 2A to 2D;

FIG. 3A shows a further valve disc of a valve;

FIG. 3B shows a further valve disc of a valve;

FIG. 3C shows a further valve disc of a valve;

FIG. 3D shows a further valve disc of a valve;

FIG. 4 shows another valve;

FIG. 5A an embodiment of a separating element in a valve;

FIG. 5B an embodiment of a separating element in a valve;

FIG. 5C an embodiment of a separating element in a valve;

FIG. 6 shows an illustration of the improvement achieved by the valve.

### DETAILED DESCRIPTION

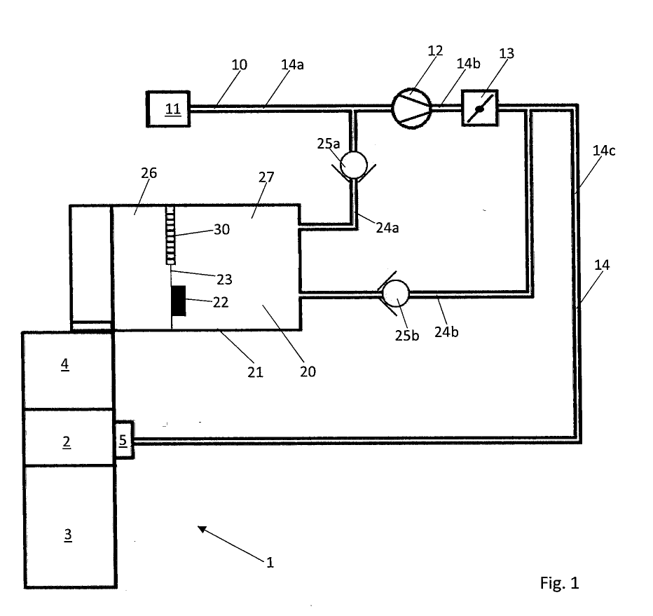

FIG. 1 shows an internal combustion engine 1 having a ventilation system.

The internal combustion engine 1 comprises a crankcase 3, a cylinder head 2, and a valve cover 4. The intake tract 10 of the internal combustion engine has a fresh-air filter 11, a compressor 12 and a throttle 13, which are connected to one another via an intake line 14 having the sections 14a and 14b and are connected to an intake manifold 5 via the section 14c. The blow-by gases arising in the crankcase 3 are directed towards an oil separator 20 via ventilation lines which are not shown in full here. The oil separator 20 is arranged here on the valve cover 4 and can be regarded as a section of a ventilation line. The oil separator 20 has a housing 21 which is divided by a dividing wall 23 into a pressure-side chamber 26 and a suction-side chamber 27. Arranged in the dividing wall 23 is an oil separator 22, via which the blow-by gases can normally be directed from the crankcase 3 to the intake tract 10. To this end, the suction-side chamber 27 is connected by two lines 24a and 24b to the intake line 14, in particular to the sections 14a and 14c. The section 24a ends in the section 14a of the intake line upstream of the compressor 12, while the section 24b ends in the section 14c of the intake line downstream of the compressor and here also downstream of the throttle 13. Non-return valves 25a and 25b are arranged in both line sections 24a and 24b.

During full-load operation, the compressor 12 in the section 14a generates a strong negative pressure, so that the blow-by gases are directed from the suction-side chamber 27 into the section 14a. During no-load operation, the throttle 13 is closed, so that a strong negative pressure prevails in the section 14c. In this case, the blow-by gases are directed from the suction-side chamber 27 into the intake line 14 via the line 24b.

Arranged in the dividing wall 23 is an oil separator 22 which is configured such that a sufficient separation of oil mist and oil droplets from the blow-by gases is ensured during normal operation. Also arranged in the dividing wall 23 is a valve 30, which is in the closed state during normal operation.

The valve 30 is configured such that, when the oil separator 22 is non-functional (for example is clogged or sooted) or in the event of extremely high volumetric flow rates of blow-by gas which the oil separator alone cannot allow to pass, said valve opens and enables the blow-by gases to pass from the pressure-side chamber 26 to the suction-side chamber 27. At the same time, the valve ensures a basic separation of oil mist and oil droplets from the blow-by gases in its open state. This prevents entirely uncleaned blow-by gases from being directed into the intake line 14.

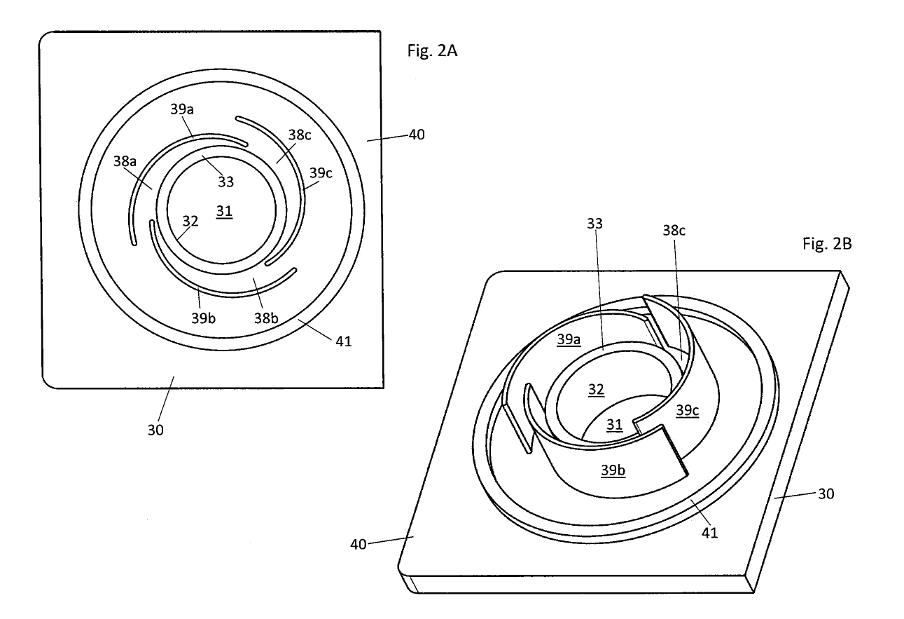

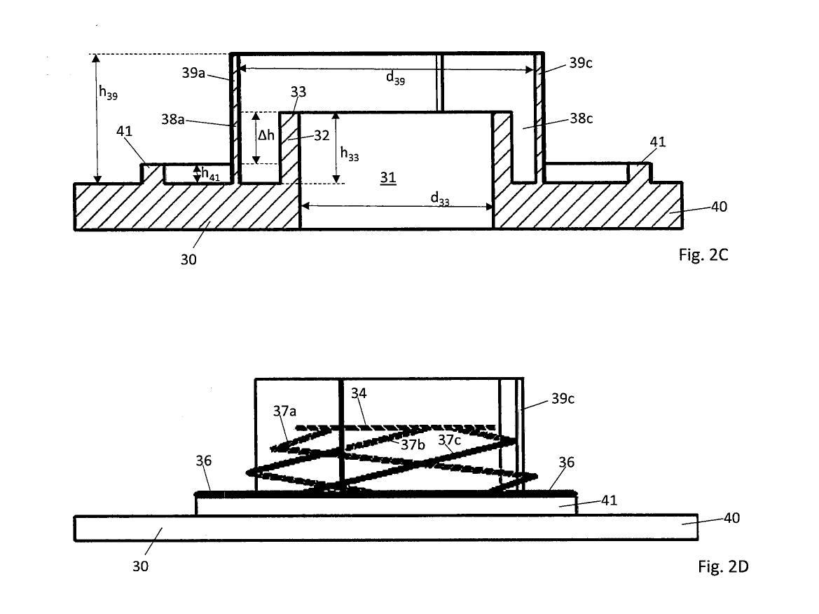

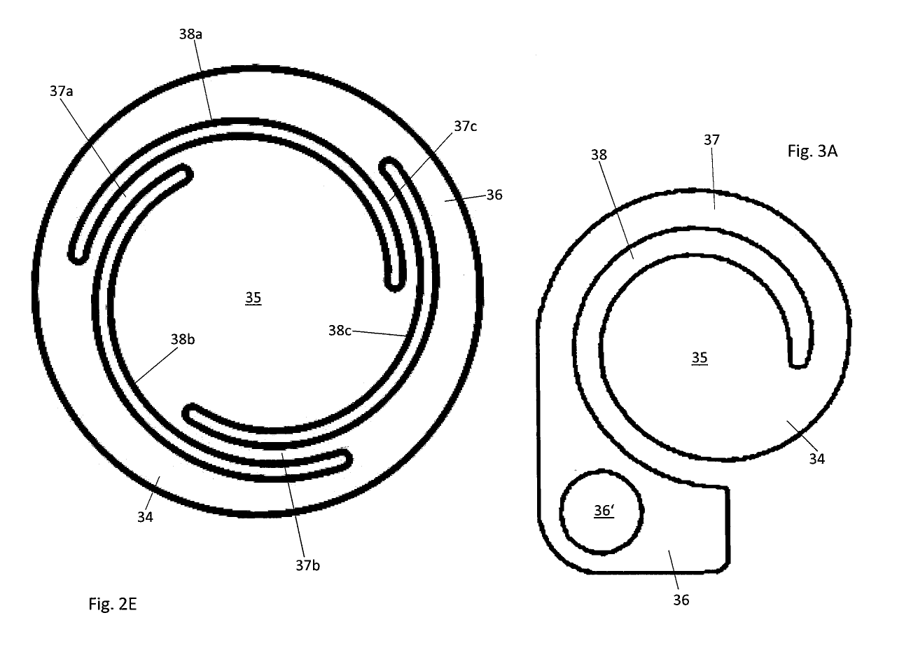

FIGS. 2A to 2E show a valve in different views. FIG. 2A shows a view of the valve 30 from above, without the valve closure member. The valve 30 has a valve seat 32, which is provided with a base plate 40 and a valve bearing member 33 which protrudes in a ring-shaped manner from the base plate 40 towards the viewer from the base plate 40. Said valve bearing member is a circumferentially closed web. Adjacent to the web, a number of separating elements 39a to 39c protrude from the base plate 40, the height of the separating elements 39a to 39c above the base plate 40 being greater than the height of the web or valve seat 32.

The valve bearing member surrounds a valve opening 31. Said valve bearing member is in turn surrounded, together with the separating elements 39a to 39c, by a retaining region 41 which likewise protrudes in a web-like manner from the base plate 40 towards the viewer.

FIG. 2B shows a side view of the valve from FIG. 2A. The separating elements 39a to 39c completely surround the valve bearing member 33 in the radial direction in an overlapping manner. If a valve closure member is arranged on the valve bearing member 33 in a manner not shown here and forms between the valve closure member and the valve bearing member 33 an annular gap for the passage of gases, said gases are deflected in the radial direction and are directed towards the separating elements 39a to 39c. The latter form baffle separating plates. A lateral deflection also takes place at the separating elements 39a to 39c, so that the gases can flow through both upwards in the viewing direction and also laterally between the separating elements. When flowing off laterally, the gases will additionally be subjected to a circular movement, so that a centrifugal separating function is also realized.

FIG. 2C shows a sectional view of the valve as shown in the two FIGS. 2A and 2B. The separating elements 39a and 39c are produced and connected in one piece with the valve seat 32 and the base plate 40. Since all the webs 32, 39a to 39c and 41 protrude in parallel perpendicular to the plane of the base plate 40, this element shown in FIG. 2C has no undercuts and therefore can be produced inexpensively, for example using the injection moulding method. Here, the one-piece component is made of glass-fibre-reinforced PA 6.6. The diameter d₃₁ of the valve opening is 15 mm, while the distance d₃₉ between the baffle separating plates 39a and 39c is 20 mm. The baffle separating plates 39a and 39c are each rectangular and both have a constant protruding height h₃₉ of 11 mm above the base plate. The protruding height h₃₂ of the circumferential web 32 is 5.8 mm, and the protruding height h₄₁ of the webs of the retaining region 41 is 2.8 mm.

FIG. 2D shows the same valve in side view, the valve disc 34 now also being shown. Said valve disc has a retaining element 36 which extends along the retaining region 41 and is connected to the latter. Extending inwardly from said retaining element 36 are spiral-shaped retaining arms 37a to 37c, which merge into the valve closure member 34.

FIG. 2E shows a vertical plan view of the valve disc 34, which is produced here entirely as a punched component from a spring-steel sheet having a thickness of 0.15 mm. The circumferential retaining element 36 is located on the outer circumferential edge of the valve disc 34. The valve closure member 35 is arranged in the centre. The valve closure member 35 and the retaining element 36 are connected to one another via flexible retaining arms 37a to 37c. The retaining arms are arranged in a spiral shape, so that the valve closure member 35 can lift out of the plane of the drawing under suitable pressure conditions. Due to the spiral shape of the retaining arms 37a and 37c, however, said valve closure member will also rotate about its central axis, which is perpendicular to the plane of the drawing.

To form the retaining arms 37a to 37c, through-openings 38a to 38c are formed between the retaining arms. These through-openings 38a to 38c then receive the separating elements 39a to 39c shown in the preceding sub-figures. The separating elements and the through-openings are dimensioned such that they do not make contact with one another and consequently the valve closure member 35 can lift out of the plane of the drawing in FIG. 2E in a friction-free manner.

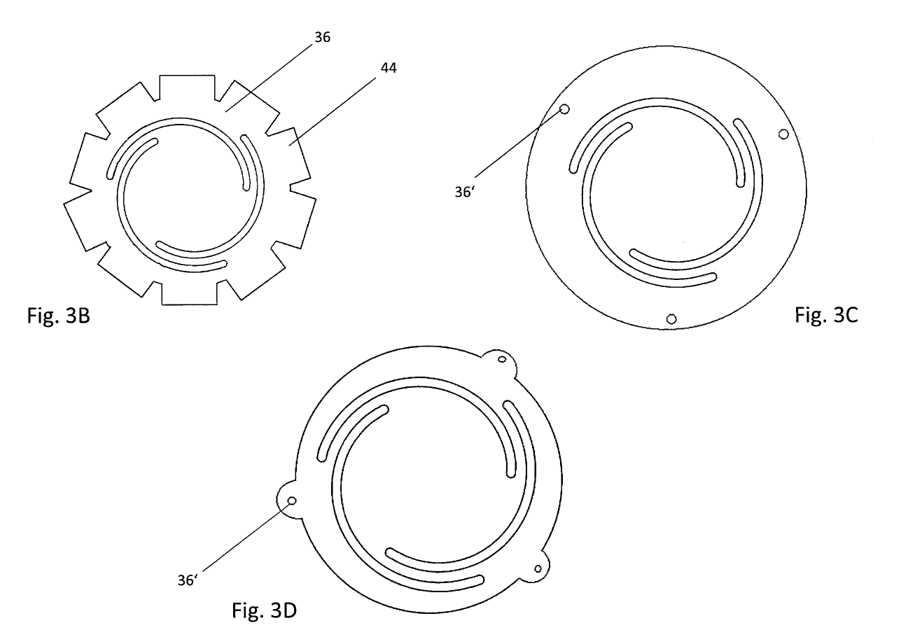

FIG. 3A shows another valve disc 34 of a valve. This has a retaining element 36 with a through-opening 36′ for fastening elements, for example pins, rivets or screws. Extending inwardly from this retaining element 36 is a single retaining arm 37 which runs in a spiral shape and tapers towards the valve closure member 35. Formed between the valve closure member 35 and the retaining arm 37 is a likewise spiral-shaped through-opening 38, in which a correspondingly designed separating element can be arranged. This separating element can extend from the inner end of the through-opening 38 along the entire circumference of the valve closure member 35 and consequently can completely and in one piece surround the valve closure member 35. It may extend beyond the through-opening 38.

With a valve designed in this way, the gas can flow radially from the slot-shaped opening that exists between the valve bearing member and the valve closure member 35 in the open state of the valve towards the separating element arranged in the through-opening 38 and is deflected from there in a circular movement parallel to the bearing plane of the valve closure member 35. The use of such a valve disc 35 and of a separating element designed in a manner corresponding to the through-opening 38 thus leads to the formation of an additional oil separator.

FIG. 3B shows a further valve disc 34 of a valve 30, which is similar to the valve disc shown in FIG. 2E. However, in the valve disc of FIG. 3B, the outer edge of the valve disc 34 comprises locking teeth 44, which are able to engage with an annular snap-in geometry outside of the retaining region 41 of valve 30. The teeth 44 thus are guided upon lift-of or closure of the valve disc in lift-of direction and closing direction by said snap-in geometry. The locking thereby prevents an (excessive) spin of the valve discs when opening the bypass valve. The number and width of the locking teeth 44 is thereby variable or can be optimized for design of the valve.

In FIG. 3C, a valve disc 34 is shown, which is similar to that of FIG. 3B. In place of the teeth at the outer edge, the valve disc 34 now comprises through holes 36′, with which guide elements, e. g. pins, rivets or screws, can engage. This guidance of the through holes 36′ in FIG. 3C also prevents twisting of the valve disc 34 upon opening or closing of the valve.

In FIG. 3D, a further valve disc 34 is shown, which is similar to the valve disc 34 shown in FIG. 3C. In contrast to the valve disc 34 shown in FIG. 3C, the through holes 36′ are now arranged in half round flaps 50, which protrude from the peripheral edge of the valve disc 34.

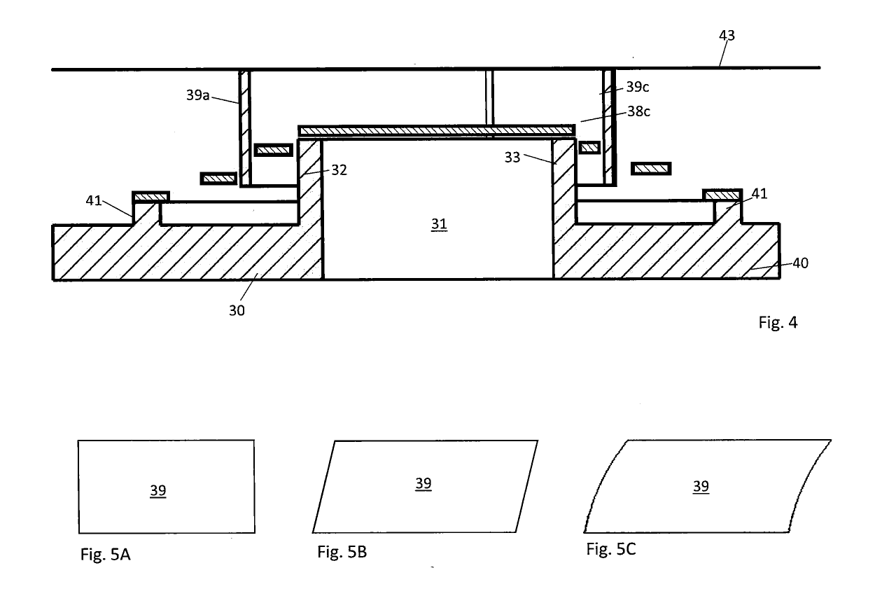

FIG. 4 shows another embodiment of a valve in cross-section. In general, this valve is designed in the same way as in FIG. 2. However, the separating elements 39a to 39c are not formed in one piece with the base plate 40 and the valve seat 32. Instead, they are now fastened to an element 43, which is located downstream of the gas flow. The separating elements 39a to 39c protrude from this element 43 towards the base plate 40 and, in the same way as in FIG. 2, extend through openings between the valve closure member 35, the retaining arms 37 and the retaining element 36/retaining region 41.

FIGS. 5A to 5C show side views of different embodiments of separating elements 39.

FIG. 5A shows a rectangular separating element 39, as also used for example in FIG. 2B. The diagram in FIG. 5 is a plan view and does not take account of the curvature of the retaining element 39 around the central axis of the valve 30. This curvature depends on the curvature of the retaining arms and of the through-openings between the valve closure member, the retaining arms and the retaining element, and can be adapted accordingly.

FIG. 5B shows a trapezoidal separating element 39. Due to the trapezoidal shape, the rotational movement of the valve closure member 35 during the opening and closing of the valve is taken into account so that the ends of the through-openings 37 can always maintain the same distance from the separating element 39.

FIG. 5C shows another embodiment of the trapezoidal separating element shown in FIG. 5B. The opposite side faces which protrude vertically from the base plate 40 are now curved in order to copy more accurately the rotational movement of the valve closure member.

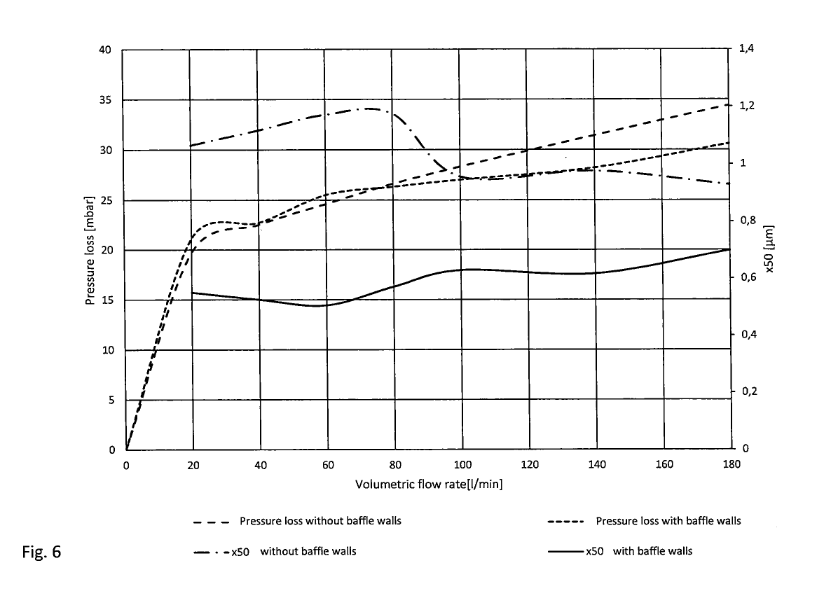

FIG. 6 shows at one side a measurement of the pressure loss through the valve as a function of the volumetric flow rate through the valve (dashed lines, left-hand scale). It can be seen that an additional pressure loss due to the additional use of separating elements occurs only at relatively large volumetric flow rates, here of at least 75 l/min, and is less than 15%. At low volumetric flow rates, the pressure loss is even reduced, and this can be attributed to additional vibration effects.

At the other side, FIG. 6 shows a measurement of the ×50 value, that is to say the particle size of the smallest particles that are 50% separated out (continuous and dash-dotted line, right-hand scale). It can be seen here that, by using the baffle walls, the ×50 value can be reduced at least to half as large particles at least for volumetric flow rates below 82 l/min, in particular even considerably further between 40 and 701/min. A clear reduction in the ×50 value is also achieved above 82 l/min, namely by at least ⅓.

The oil separation is thus considerably improved by a valve, without this leading to considerable increases in pressure loss.

1-21. (canceled)

22. A valve comprising
a valve disc having a valve closure member, a retaining element for the valve closure member, said retaining element at least partially surrounding the valve closure member, and at least one retaining arm, which connects the retaining element and the valve closure member to one another in a flexible manner, and
a valve seat having a valve opening and a valve bearing member, which surrounds the valve opening and which is designed for the bearing of the valve closure member such that, in the closed position of the valve, the valve closure member bears against the valve bearing member and closes the valve, wherein
the retaining element, the at least one retaining arm and the valve closure member are designed such that at least one through-opening is formed between at least two of the parts of the valve disc including the retaining element, the at least one retaining arm and the valve closure member, and
the valve has at least one separating element, which is arranged such that it extends through the at least one through-opening at least in the open position of the valve.

23. The valve according to claim 22, wherein at least one, several or all of the separating elements extends through the at least one through-opening in each position of the valve.

24. The valve according to claim 22, wherein the valve disc has at least two retaining arms and at least two through-openings, and in each case at least one separating element is arranged in at least two of the through-openings.

25. The valve according to claim 22, wherein one, several or all separating elements are designed as a baffle element, including a baffle plate, and/or are formed of an open porous material or with an open or closed porous and/or lattice-like surface.

26. The valve according to claim 22, wherein one, several or all separating elements are formed in one piece with the valve seat or are connected to the valve seat by means of a form fit, friction fit and/or adhesive join, including after manufacture of the separating elements.

27. The valve according to claim 22, wherein one, several or all separating elements are mounted on the side of the valve closure member that faces away from the valve seat or are mounted laterally in relation to the valve closure member.

28. The valve according to claim 22, wherein one, several or all separating elements are connected to one another, including in the shape of a circle, by web-like elements.

29. The valve according to claim 22, wherein one, several or all separating elements are designed as baffle plates which extend along a respective associated through-opening, and the end thereof that is at the smallest distance from the valve closure member, and including also the end thereof that is at the greatest distance from the valve closure member, is angled relative to the movement direction of the valve closure member during opening of the valve.

30. The valve according to claim 29, wherein the angled end of a baffle plate is angled in such a way that the distance between the end of the baffle plate and the adjacent end of the associated through-opening remains substantially constant during opening and/or closing of the valve or changes between the open position and the closed position of the valve.

31. The valve according to claim 22, wherein two, several or all separating elements overlap one another as viewed in the radial direction from the valve closure member.

32. The valve according to claim 22, wherein the entirety of the separating elements extend around the entire circumference of the valve closure member as viewed in the radial direction from the valve disc.

33. The valve according to claim 22, wherein one, several or all separating elements are flat and the surface thereof extends substantially or completely perpendicular to the bearing plane of the valve closure member and/or substantially or completely in the circumferential direction around the valve closure member.

34. The valve according to claim 22, wherein the retaining arms run in a curved manner, including in a spiral shape, between the retaining element and the valve closure member, including with a concave curvature as viewed outwards in the radial direction from the valve closure member, and/or with through-openings therebetween which run in a correspondingly curved manner, including in a spiral shape, around the valve closure member.

35. The valve according to claim 22, wherein the circumferential edge of the valve closure member has substantially a rounded shape.

36. The valve according to claim 22, wherein the valve bearing member is designed as a web or collar which runs along the edge of the valve opening.

37. The valve according to claim 22, wherein at the points where a separating element extends through the through-openings, the clear width of the through-openings in each valve state is greater than the thickness of the separating elements, in that the separating elements are at a predefined distance from the edges of the through-openings.

38. The valve according to claim 22, wherein the valve closure member is comprised of spring steel, including spring steel of material number 1.4310, and/or plastic, including fibre-reinforced, including glass-fibre-reinforced PA (polyamide), PPS (polyphenylene sulphide), PPA (polyphthalamide), PI (polyimide), PEI (polyetherimide), PAI (polyamide-imide), PEEK (polyether ether ketone), PSU (polysulphone) and/or LCP (Liquid Crystal Polymer).

39. The valve according to claim 22, wherein the valve seat comprised of plastic, including fibre-reinforced, including glass-fibre-reinforced PA (polyamide), PPS (polyphenylene sulphide), PPA (polyphthalamide), PI (polyimide), PEI (polyetherimide), PAI (polyamide-imide), PEEK (polyether ether ketone), PSU (polysulphone) and/or LCP (Liquid Crystal Polymer).

40. The valve according to claim 22, wherein the valve is a bypass valve for an oil separating element, the oil separator separates oil droplets or oil mist from gas that is to be cleaned, including from blow-by gases, where the oil separator comprises at least one oil separating element through which the gas that is to be cleaned can flow.
